(19) United States
(12) Patent Application Publication
(10) Pub. No.: US 2014/0190958 A1
(43) Pub. Date: Jul. 10, 2014

(54) METHOD FOR COATING AN INSULATION COMPONENT AND INSULATION COMPONENT

(71) Applicants: Andreas Koch, Neunkirchen am Brand (DE); Eberhard Lenz, Furth (DE)

(72) Inventors: Andreas Koch, Neunkirchen am Brand (DE); Eberhard Lenz, Furth (DE)

(73) Assignee: SIEMENS AKTIENGESELLSCHAFT, MUNCHEN (DE)

(21) Appl. No.: 14/237,269

(22) PCT Filed: Jul. 19, 2012
(86) PCT No.: PCT/EP2012/064151

§ 371 Date: Feb. 5, 2014

(30) Foreign Application Priority Data
Aug. 8, 2011 (DE) 10 2011 080 620.2

(51) Int. Cl. H01B 19/04; H05B 3/18; B05D 1/36; B05D 3/14; B05D 3/02

(52) U.S. Cl. CPC H01B 19/04; B05D 3/144; B05D 3/0254; B05D 1/36; H05B 3/18
USPC 219/548; 427/536

(57) ABSTRACT

The invention relates to a method for coating an insulation component (10), having PEEK, for insulating an electrically conductive heating cable (100) comprising the following steps: 1.) at least sectionally treating the surface of the insulation component (10) with at least one cold plasma flame, and 2.) applying at least one protective layer (20) to the treated surface of the insulation component (10).

### CROSS REFERENCE TO RELATED APPLICATIONS

This application is the US National Stage of International Application No. PCT/EP2012/064151, filed Jul. 19, 2012 and claims the benefit thereof. The International Application claims the benefits of German application No. 10 2011 080620.2 DE filed Aug. 8, 2011. All of the applications are incorporated by reference herein in their entirety.

### FIELD OF INVENTION

The present invention relates to a method for coating an insulation component, comprising PEEK, for the insulation of an electrically conductive heating cable. The present invention also relates to an insulation component, comprising PEEK, for the insulation of an electrically conductive heating cable and to such an insulated electrically conductive heating cable.

### BACKGROUND OF THE INVENTION

It is known that, for the extraction of oil, there are also viable oil deposits in which the oil has to be separated from the sand in a separating process. However, in deposits in which the oil sand is not accessible by surface mining, the extraction of the oil usually takes place by heating the oil sand. As a result, the viscosity of the bound oil is reduced in such a way that it can be pumped away in a conventional manner. In the case of known methods, heated steam, heated air or similar hot gases are used for the heating of the oil sand. This entails the disadvantage that a possible way of transporting the gases into the desired position in the ground, that is to say to the site of the oil sand reserve, has to be very laboriously provided. In addition, sometimes very deep and extensive deposits mean that it is necessary to be mindful of the onerous task of dealing with the pressure loss that occurs when the gases/steams are introduced.

It is also known that induction can be used as a physical principle for the heating of materials. However, this involves the problem that, when induction cables, that is electrically conductive heating cables, are used for the extraction of oil from oil sand deposits described above, highly aggressive conditions are encountered. In particular, the heating cables must withstand sustained temperature values of over 250° C., which occur under a water vapor atmosphere and an H₂S vapor atmosphere at an overpressure of 15 bar. A simple electrically conductive heating cable, such as for example a copper cable, would not sufficiently withstand such conditions. The situation in terms of the conditions encountered also presents exceptional problems for the insulation of such heating cables. Even highly resistant plastics, such as in particular the plastic PEEK, are not sufficiently resistant to be used in a permanently stable state in such atmospheres.

The term heating cable should also be understood as including an inductor for oil sand extraction, with which the surrounding ground is induced to cause an increase in temperature during operation by means of induction.

### SUMMARY OF THE INVENTION

It is an object of the present invention to overcome the problems described above. In particular, it is an object of the present invention to provide a method that makes it possible to provide an insulation of electrically conductive heating cables which allows them to be used under the aggressive conditions encountered that are described above. It is likewise an object of the present invention to provide a corresponding insulation component and an electrically conductive heating cable insulated by it.

The aforementioned object is achieved by a method with the features of the claims. Further features and details of the invention are provided by the dependent claims, the description and the drawings. It goes without saying that features and details that are described in connection with the insulation component according to the invention and the electrically conductive heating cable according to the invention also apply in connection with the method according to the invention and vice versa, respectively, so that reference is, or can be, always made reciprocally with respect to the disclosure in respect of the individual aspects of the invention.

In the case of a method according to the invention for coating an insulation component for the insulation of an electrically conductive heating cable, this insulation component comprises PEEK. This means that PEEK (polyether ether ketone) is used as the material for the production of the insulation component. In particular, the insulation component is produced completely or substantially completely from PEEK. The insulation component serves for the insulation of an electrically conductive heating cable. For this purpose, the insulation component has the one geometrical form, so that it can be placed around the heating cable for the insulation. In particular, the insulation component is given a hollow-cylindrical form, of a length that is less than the length of the electrically conductive heating cable. Often, electrically conductive heating cables with lengths of several kilometers, for example two kilometers, are used. Corresponding insulation components in the form of a hollow cylinder are in this case made to a size of several meters, for example about 9 meters. In this way, the method according to the invention can be carried out on relatively small units, that is to say the insulation component, and it is nevertheless also possible for an electrically conductive heating cable made to a very large size to be insulated in the way according to the invention by an insulation component coated according to the invention.

A method according to the invention has the following steps for the coating of the insulation component:
treating at least portions of the surface of the insulation component with at least one cold plasma flame and
applying at least one protective layer to the treated surface of the insulation component.

The aforementioned procedure can also be described in other words as the “activation” of the surface of the insulation component in the chemical sense and the subsequent coating.

With the material PEEK it is problematic that, on account of its high resistance to aggressive conditions, this material at the same time has a high resistance with regard to reactivity. It can therefore be described as “slow to react”. This prevents a frictional connection between a coating with a protective layer and the material of the insulation component from being able to take place in a conventional way by means of adhesion-bonding methods or the like. It is only by the use of a method according to the invention that the surface of the insulation component can be activated such that this surface is chemically capable of overcoming the slowness to react inherent in the material and entering into a corresponding frictional connection with the protective layer. It should at the same time be noted that particularly good activation is obtained by the plasma flame, which is for example operated with a gas ratio of nitrogen to oxygen of 1:1. In this way, the PEEK material becomes surface-active and can enter into a load-bearing connection or a reaction with other chemicals within a commercially acceptable time.

The activation method by means of a cold plasma flame can additionally be carried out at relatively low cost. In other words: a temporary modification of the chemical properties of the insulation component is carried out at the surface thereof by the plasma flame, so that the protective layer can subsequently remain adhering. The adhering of the protective layer is important, since, during the introduction of a corresponding electrically conductive heating cable with such an insulation into extraction areas for oil sand, a necessary extensibility of up to 1% and more is necessary for the protective layer. If a frictional connection does not exist between the protective layer and the insulation component of PEEK, this would have the effect that cracks could occur in the protective layer and, in this way, the aggressive environmental conditions would bring about premature corrosion of the PEEK material, and accordingly premature failure of the heating cable.

A further advantage of a method according to the invention is that, as a result of the plasma activation of the surface of the insulation component, this activation lasts for a relatively long time. In particular, this activation remains active over several days, so that the step of treating the surface with the plasma flame can be isolated in time and location from the step of applying at least one protective layer. In particular, it is possible that the protective layer is only carried out after the fitting of the respective insulation component on the electrically conductive heating cable. This entails the advantage that the protective layer can form a closed protective layer even at the joins between individual insulation components in the longitudinal direction of the electrically conductive heating cable. In this way, still further improved shielding from the aggressive environmental conditions can be achieved.

Within the scope of the present invention, the treating of portions of the surface of the insulation component with at least one cold plasma flame should be understood as meaning that at least the portions of the surface of the insulation component that face outward after the insulation component is attached around the electrically conductive heating cable for the insulation thereof, and would accordingly come into contact with the aggressive environmental conditions, are correspondingly treated and coated. The electrically conductive heating cable is, within the scope of the present invention, preferably a copper cable with a diameter of about 100 to 160 mm. embodiments can be freely combined with one another, insofar as this is technically meaningful, without departing from the scope of the present invention.

A method according to the invention may be carried out for example with the aid of a ring, in which one or more cold plasma flames point toward the center point of this ring. In this way, in particular by a rotation about the center point of this ring, a continuous treatment of the surface of the insulation component can take place. For this purpose, an alternating voltage is preferably applied to the ring and oxygen, nitrogen and C₃H₈ are supplied via gas connections to the ring, and consequently to the plasma flame, for the generation thereof. As can be appreciated here, the particularly environmentally friendly activation is a further advantage, in that the plasma method does not cause any unnecessary exhaust gases that could be perceived as environmental pollution.

The protective layer may take various forms. In particular, it should be pointed out that not only one protective layer but also multiple protective layers may be used one on top of the other, with an identical or differing chemical and/or physical configuration. What is decisive, however, is that not only between the protective layer and the material of the insulation component but also between the individual protective layers there is a corresponding frictional or material-bonding connection, in order to achieve the requirements described further above for the elongation limit in the way according to the invention.

It may be of advantage if, in the case of a method according to the invention, at least one protective layer is applied as a sol-gel layer by a sol-gel method. In this case, the main component of a sol-gel solution used for this after application of the layer and curing or drying of the sol-gel solution is, in particular, SiO₂ or TiO₂. When the sol-gel layer is applied, it has a 99%, or approximately 99%, alcohol content. This alcohol content evaporates, so that, after the curing or drying of the sol-gel solution, SiO₂ or TiO₂ remains. In other words, a glass or ceramic sol-gel solution can be used, ceramic solutions bringing about even greater screening from the aggressive environmental conditions.

The sol-gel method is used by spraying the activated surface for example with a sol-gel solution. This solution comprises a solvent, for example an alcohol. This evaporates very quickly or immediately and leaves behind as a result of the evaporation a thin film with oxidic and pre-oxidic nano particles. The application and the evaporation of the solvent can additionally ensure that a substantially or completely closed film surrounds the material of the insulation component. In this way there is produced, as it were, an impermeable, vitreous oxide layer. This oxide layer has on the one hand the advantage that it protects the material of the insulation component, in particular the PEEK, in the desired way from the aggressive environmental conditions. In addition, the oxide layer is capable of entering into a good adhesive bond with the surface of the material of the insulation component during curing. This makes it possible that a material extension of over 1% of the protective layer can be withstood. The reason for this is that, the thinner it becomes, a material can withstand increasingly greater linear deformation without showing any incipient formation of tears. In this way it is ensured that the desired shielding from the aggressive environmental conditions is provided not only after carrying out the method according to the invention but also during introduction into the desired position in the ground for the heating of oil sand.

It may likewise be of advantage if, in the case of a method according to the invention, the protective layer is applied in such a way that a layer thickness of at least 2 μm is achieved. A layer thickness of between 2 and 5 μm is preferred. It should be pointed out in this respect that the protective layer may also consist of individual protective layer films, which, when arranged one on top of the other, can achieve a correspondingly greater protective layer thickness, of in particular up to 30 μm. 2 μm should be understood here as meaning a minimum layer thickness to avoid open locations and continuous tears in the protective layer. Such a continuous tear should be conceived here as being in relation to the radial alignment of the insulation component. This would lead to the occurrence of a leakage, by which the material of the insulation component, that is in particular the PEEK, would be exposed directly to the aggressive environmental conditions. There would accordingly be a corrosion leakage at this location, potentially leading to failure of the insulation, and accordingly to a short-circuit of the electrically conductive heating cable during its use. Carrying out a method according to the invention with the minimum layer thickness of 2 μm consequently has the effect that the functional reliability for the use of an insulated electrically conductive heating cable is significantly increased by a method according to the invention.

It may likewise be advantageous if, in the case of a method according to the invention, the step of applying the protective layer is carried out at least twice. In this way, the layer thickness of the protective layer is increased. In particular, there is an increase in the layer thickness to about 30 μm, so that still better protection from corrosion leakage can be achieved. In this respect, the individual steps of applying the protective layer are carried out in such a way that drying or curing of the previously applied protective layer could only partly take place, or not at all, between the individual application steps. This entails the advantage that, at the time that the next protective layer is applied, the protective layer lying thereunder is still capable of entering into a frictional connection, for example by material bonding. When applying multiple protective layers one on top of the other, it is possible to use an identical protective layer in each case and also to use different protective layers. In particular, different protective layers can be arranged one on top of the other in order to combine their protective quality in different respects to form a combined, and correspondingly superior, protective layer.

It may also be advantageous if, in the case of a method according to the invention, after the application of the protective layer, there follows at least one drying step for the protective layer. This drying step is carried out at a temperature above room temperature, in particular of between 100° C. and 200° C. A temperature range of between 120° C. and 180° C. is preferred. In this way, the rate at which the method is carried out can be speeded up. The drying step serves the purpose of speeding up the curing of the applied protective layer. It should be pointed out in this respect that, when using multiple protective layer films that are applied one on top of the other, the drying step should be carried out at the end, that is to say after the last application of a protective layer film. In this way, the individual protective layers can be applied one on top of the other relatively quickly one after the other and finally, by means of the drying step, rapid completion of the insulation component by a method according to the invention can remain ensured.

The drying step may take place for example by heating up the insulation components together in an oven before the fitting to the heating cable. It goes without saying that it is also possible that a method according to the invention is carried out on a single production line, so that an activation of the insulation component, a coating of the insulation component and subsequently, in particular, a drying of the insulation component can take place substantially continuously in the continuous method.

It may be a further advantage if, in the case of a method according to the invention, at least one protective layer is applied as an adhesive, in particular directly on the surface of the insulation component. The embodiment according to this dependent claim achieves the advantage that the frictional bond between an adhesive and the material of the insulation component, that is in particular the PEEK, can be formed particularly strongly. In this case, the adhesive may already itself represent the final protective layer, or else only part of this protective layer, which in turn is provided with an additional protective layer provided on it. The adhesive should in this case be understood in particular as meaning an adhesion promoter, for example for a sol-gel method in the case of this embodiment. A phenol novolac cyanate ester may be used for example as the adhesive.

In order to apply the adhesive, a ring brush should preferably be used, arranged in such a way that, during application, the insulation component is guided through this ring brush in such a way that, after application, the applied adhesive material in the still liquid state runs down along the insulation component again in the direction of the ring brush as a result of being moved by gravitational force. In this way, a substantially constant, and in particular closed, protective layer can be formed. In addition, the occurrence of sudden changes in thickness with regard to the layer thickness of the protective layer is avoided.

It is pointed out that, within the scope of the present invention, not only a single protective layer but also a multiplicity of protective layers can be provided one on top of the other. In particular, a single protective layer or protective layer film is formed as an adhesive or as a sol-gel layer, that is as a vitreous oxide layer. Multiple layers of adhesive or a sol-gel layer are also conceivable within the scope of the present invention.

In particular, a combination of an adhesive and a sol-gel layer is also conceivable, the adhesive having been applied in particular directly to the surface of the insulation component.

A method according to the invention may be developed to the effect that, after the application of the protective layer in the form of the adhesive, a curing step is carried out in such a way that the adhesive becomes dimensionally stable without already curing completely. This has the effect that further protective layers can also be applied. The further application may take place for example in a next process step, by spraying the surface with an alcoholic sol-gel mixture. For fire safety reasons, the curing step is preferably performed at a relatively great distance when operating with flames or with radiant heaters. The adhesive preferably exhibits a thermal decomposition point after its curing of from 400 to 420° Celsius. Accordingly, the adhesive itself can also already develop a protective effect, and be understood as a protective layer within the scope of the present method. This means that the adhesive itself also brings about a shielding from the aggressive environmental conditions.

It is likewise advantageous if, in the case of a method according to the invention, it is designed for the coating of an insulation component with a hollow-cylindrical form, in particular of a length that is less than the length of the electrical heating cable. This allows a compact unit of the insulation component with a length of for example less than about 10 m to be treated and coated according to the invention in high numbers. By combining a multiplicity of insulation components, the method can also be applied in the case of much longer electrical heating cables, by the individual insulation components being used one adjoining the other. Apart from reducing the production costs, this also reduces the effort involved in storing and transporting the insulation components.

A further advantage is achieved whenever, in the case of a method according to the invention, fitting on the electrical heating cable is carried out after the treatment of the surface of the insulation component with at least one cold plasma flame and before the application of the at least one protective layer to the treated surface of the insulation component. This allows a particularly effective protective effect to be achieved by the coating. This is based in particular on the fact that, in the case of a coating with the protective layer that is carried out after the fitting, the joins between individual insulation components adjoining one another are also treated and coated in the way according to the invention. Consequently, a continuous, or substantially continuous, protective layer is produced over the course of the entire electrical heating cable irrespective of the number of insulation components that are used and adjoin one another.

It is also advantageous if, in the case of a method according to the invention, the treatment of the surface and the application of the at least one protective layer is carried out around the insulation component. In particular in the case of rotationally symmetrical electrical heating cables, for example with a round cross section, in this way a completely surrounding protective layer is obtained, so that there is protection from corrosion on all sides.

It is also possible within the scope of the present invention that the treatment of the surface of the insulation component with at least one cold plasma flame is carried out with a ring surrounding the insulation component. Such a ring is advantageous in particular when producing a peripheral protective layer, as described in the previous paragraph. This allows low-cost production to be carried out, in particular in a continuous or semi-continuous way.

In addition, it is of advantage if, in the case of a method according to the invention, at least two protective layers, in particular all of the protective layers, consist of the same material, or substantially the same material. Great layer thicknesses can consequently be applied layer by layer, without differences in material, such as different thermal expansions or the like, potentially leading to mechanical or electrical or thermal problems.

A further subject matter of the present invention is an insulation component, comprising PEEK, for the insulation of an electrically conductive heating cable. This insulation component is distinguished by the fact that at least portions of the surface of the insulation component are provided with a protective layer. An insulation component according to the invention is preferably formed in such a way that it can be produced by a method according to the invention. Accordingly, an insulation component according to the invention has the same advantages as have been explained in detail with reference to a method according to the invention.

A further subject matter of the present invention is an electrically conductive heating cable that has been insulated by at least one insulation component according to the invention, which has the features of the present invention. A correspondingly electrically conductive heating cable accordingly has the same advantages as have been explained in detail with regard to an insulation component according to the invention and with regard to a method according to the invention.

### BRIEF DESCRIPTION OF THE DRAWINGS

The present invention is explained in more detail on the basis of the appended figures of the drawing. The terminology thereby used, “left”, “right”, “upper” and “lower”, relates to an alignment of the figures of the drawing with the reference numerals normally legible. In the drawing:

FIG. 1 shows in a schematic view one possibility of carrying out the method according to the invention,

FIG. 2 shows an embodiment of an insulation component produced in a way according to the invention,

FIG. 3 shows a further exemplary embodiment of an insulation component produced according to the invention,

FIG. 4 shows a further exemplary embodiment of an insulation component produced according to the invention,

FIG. 5 shows a further exemplary embodiment of an insulation component produced according to the invention,

FIG. 6 shows a further exemplary embodiment of an insulation component produced according to the invention, and

FIG. 7 shows a further exemplary embodiment of an insulation component according to the invention.

### DETAILED DESCRIPTION OF THE DRAWINGS

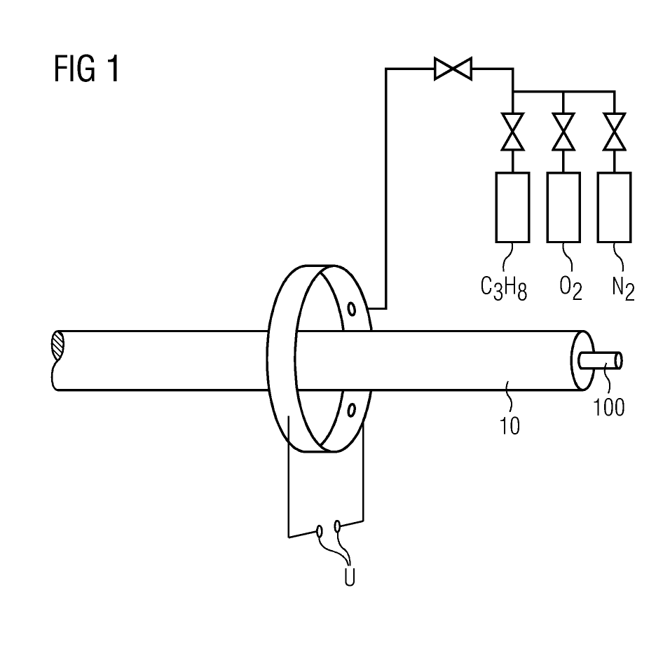

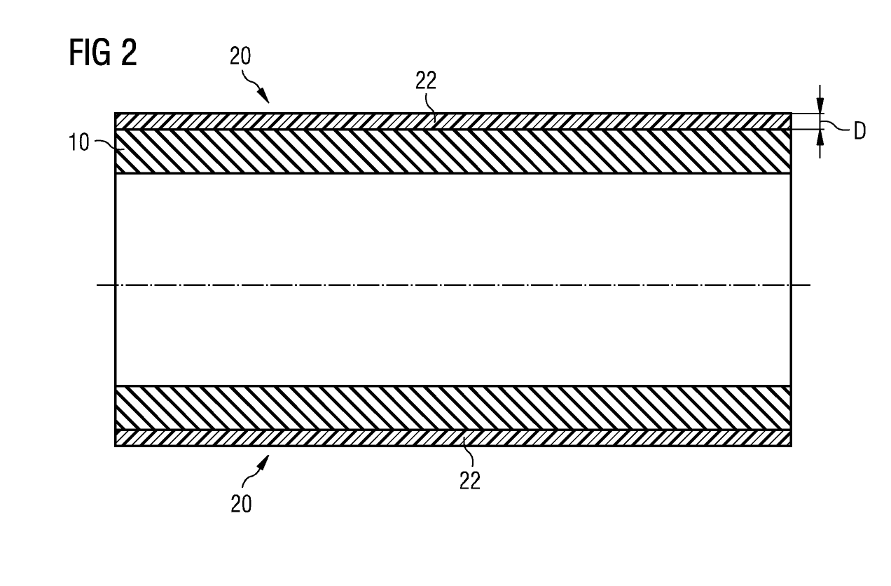

The way in which a method according to the invention is carried out is to be explained on the basis of FIG. 1. A plasma flame ring, which is schematically represented in FIG. 1 and may be charged with C₃H₈, is provided for carrying out the method. In addition, a connection for an alternating voltage is provided at the lower region of the ring, in order to generate the plasma in the desired way. For the treatment of the surface of the insulation component 10, the ring is moved, in particular in a rotating way, along the axis of the insulation component 10. The surface of the insulation component 10 is thereby activated. This activation overcomes the slowness to react and in this way makes a frictional connection to the insulation component possible. A next production step is the application of a protective layer 20. The result of such a production step is represented in FIG. 2.

FIG. 2 shows by way of example an embodiment of an insulation component 10 in a schematic cross section. This is provided with a protective layer 20. The protective layer 20 is in the case of this embodiment a sol-gel layer 22, with a thickness D, which is greater than or equal to 2 μm.

The sol-gel method has in this case preferably been carried out in such a way that the desired film with a desired layer thickness has been produced by way of evaporation of a solvent. A curing process has subsequently been carried out, leaving behind a vitreous oxide layer of nano particles.

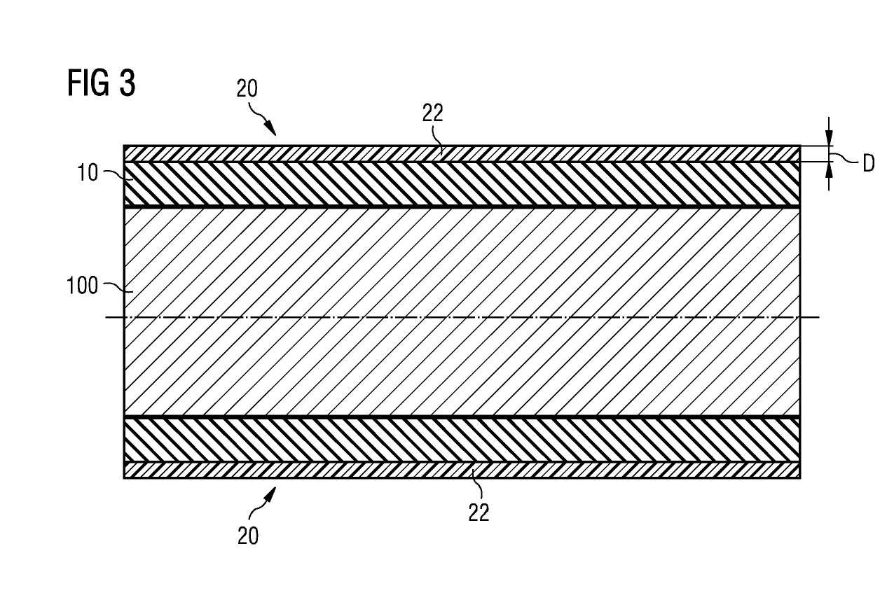

FIG. 3 shows the insulation situation with an insulation component 10 according to the invention as shown in FIG. 2. There, the insulation component 10 is enclosing the electrically conductive heating cable 100 in an insulated way. In this arrangement, the heating cable may be used in the aggressive environmental conditions that are encountered for example in the extraction of oil sand for the heating thereof.

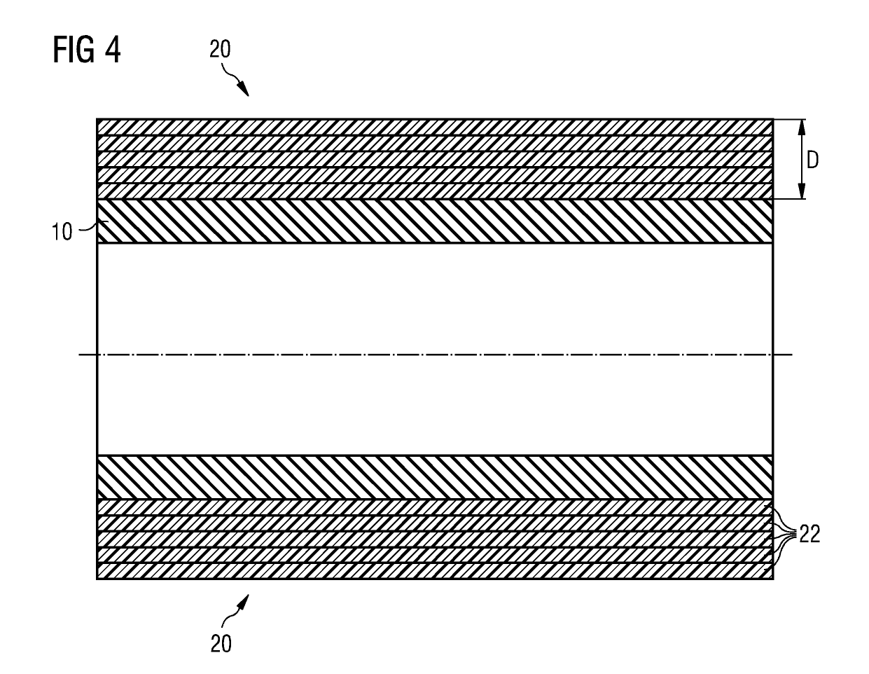

In FIGS. 4, 5, 6 and 7, alternative embodiments of an insulation component 10 according to the invention obtained by a method according to the invention are represented. These differ by differing types of layer thickness and a differing number of layer thicknesses.

In FIG. 4, an embodiment in which five protective layers produce a combined protective layer 20 is shown. In this case, five films of a sol-gel solution have been produced one on top of the other as a respective sol-gel layer 22. In this way it has been possible to increase the layer thickness D, in particular to a range of 30 μm.

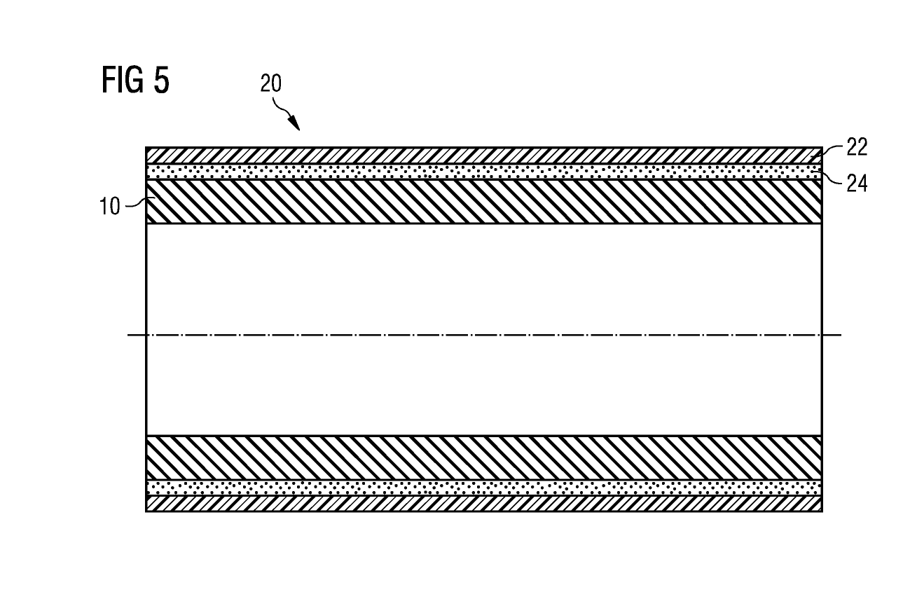

FIG. 5 shows the possibility of combining different materials for the protective layer 20. The insulation component 10 of this embodiment has first been coated with an adhesive 24. This adhesive 24 has been only partly made to cure in a curing process, so that it has remained dimensionally stable but still viscous. Subsequently, a sol-gel layer 22 has been applied to the adhesive 24 in a sol-gel method. In this way it has been possible to achieve a frictional connection between the insulation component 10 and the adhesive 24 and also between the adhesive 24 and the sol-gel layer 22. This has allowed the chemical constituent properties, and consequently the protective mechanisms, of the adhesive layer 24 and the sol-gel layer 22 to be combined with one another, in order to withstand even better the aggressive environmental conditions with regard to the protection of the insulation component 10 during its use.

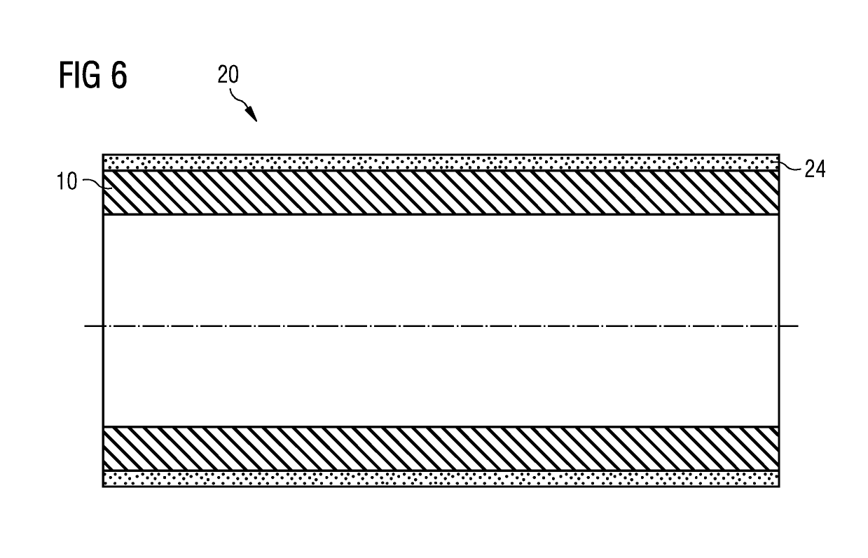

In FIG. 6, an alternative embodiment of the insulation component 10 is represented. In the case of this embodiment, the protective layer 20 consists of an adhesive 24. This has likewise been applied in a way such as that prescribed by a method according to the invention, that is after the plasma activation of the surface of the insulation component 10.

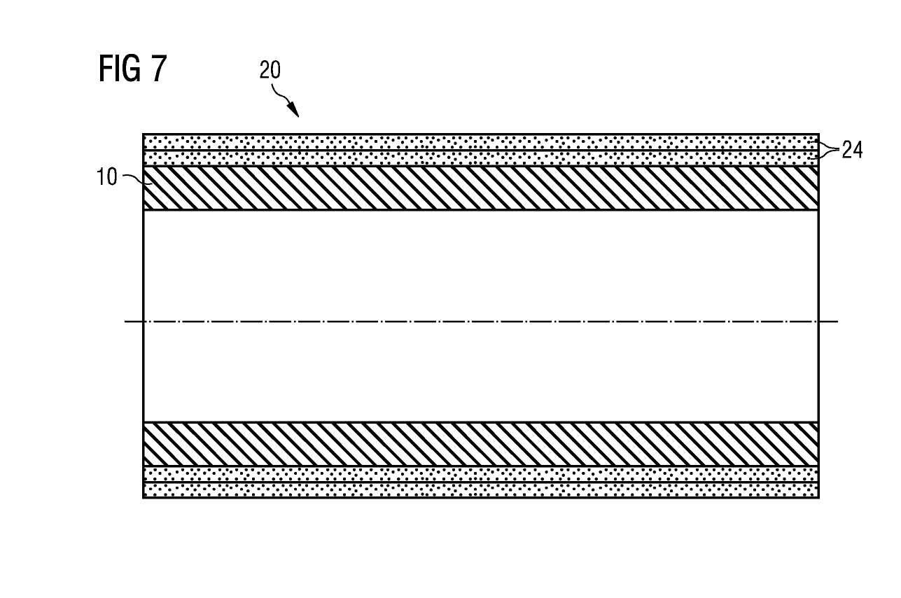

In FIG. 7 it is shown that the adhesive may also be provided doubly or even multiply as an adhesive layer 24. In this way, the layer thickness D is likewise increased, so that the shielding effect from the aggressive environmental conditions is increased. A further advantage of increased layer thicknesses D is that in this way the mechanical stability of the protective layer 20 can be increased. In this way, tears can be minimized still further during use, so that the long-term stability of the correspondingly insulated electrically conducting heating cable 100 has been increased even further.

The aforementioned embodiments describe the present invention only in the context of examples. Accordingly, individual features relating to these exemplary embodiments can be freely combined with one another, insofar as this is technically meaningful, without departing from the scope of the present invention.

1-15. (canceled)

16. A method for coating an insulation component, comprising PEEK (polyether ether ketone), for the insulation of an electrically conductive heating cable, comprising:
treating at least portions of the surface of the insulation component with a cold plasma flame; and
applying a protective layer to the treated surface of the insulation component.

17. The method as claimed in claim 16, wherein the protective layer is applied as a sol-gel layer by a sol-gel method.

18. The method as claimed in claim 17, wherein a main component of the sol-gel solution after drying thereof is SiO₂ or TiO₂.

19. The method as claimed in claim 16, wherein the protective layer is applied in such a way that a layer thickness of at least 2 μm is achieved.

20. The method as claimed in claim 16, wherein applying the protective layer is carried out at least twice so that the layer thickness of the protective layer increases.

21. The method as claimed in claim 16, wherein after the application of the protective layer, there follows a drying step for the protective layer, which is carried out at a temperature above room temperature.

22. The method as claimed in claim 16, where the drying step for the protective layer is carried out at between 100° C. and 200° C.

23. The method as claimed in claim 16, wherein the protective layer is applied as an adhesive directly on the surface of the insulation component.

24. The method as claimed in claim 23, wherein after the application of the protective layer in the form of the adhesive, a curing step is carried out in such a way that the adhesive becomes dimensionally stable without already curing completely.

25. The method as claimed in claim 16, wherein the coating of an insulation component includes a hollow-cylindrical form.

26. The method as claimed in claim 25, wherein the hollow-cylindrical form includes a first length that is less than a second length of the electrical heating cable.

27. The method as claimed in claim 16, wherein the fitting on the electrical heating cable is carried out after the treatment of the surface of the insulation component with a cold plasma flame and before the application of the protective layer to the treated surface of the insulation component.

28. The method as claimed in claim 16, wherein the treatment of the surface and the application of the protective layer is carried out around the insulation component.

29. The method as claimed in claim 16, the treatment of the surface of the insulation component with a cold plasma flame is carried out with a ring surrounding the insulation component.

30. The method as claimed in claim 16, wherein at least two protective layers, in particular all of the protective layers, consist of the same material.

31. An insulation component for the insulation of an electrically conductive heating cable, comprising:
PEEK (polyether ether ketone),
wherein at least portions of the surface of the insulation component are provided with a protective layer.

32. The insulation component as claimed in claim 31, wherein the protective layer is produced by the method according to claim 16.

33. An electrically conductive heating cable, insulated by an insulation component according to claim 31.
